(19) United States
(12) Patent Application Publication
(10) Pub. No.: US 2025/0360636 A1
(43) Pub. Date: Nov. 27, 2025

(54) Adjustable Blade Assembly Having Magnetic Tensioning

(71) Applicant: ANDIS COMPANY, STURTEVANT, WI (US)

(72) Inventors: Joseph Novak, Milwaukee, WI (US); Jassen R. Miller, Trevor, WI (US)

(21) Appl. No.: 18/670,441

(22) Filed: May 21, 2024

(51) Int. Cl. B26B 19/04

(52) U.S. Cl. CPC B26B 19/04

(57) ABSTRACT

A hair cutting device or clipper is provided with a detachable magnetic blade assembly. The hair cutting device includes a cutting blade, a stationary blade and coupled to and extending through the cutting blade. The magnet creates an attractive or repulsive force between the cutting blade and the stationary blade.

### BACKGROUND OF THE INVENTION

The present invention relates generally to the field of hair cutting devices, such as hair clippers or hair trimmers. The present invention relates specifically to a magnetic tensioning assembly configured to provide tension between a reciprocating blade and a stationary blade of the blade assembly.

### SUMMARY OF THE INVENTION

One embodiment of the invention relates to a magnetic blade assembly. The magnetic blade assembly includes a stationary blade, a cutting blade, a magnet holder and a magnet. The stationary blade includes teeth extending along a first blade edge. The cutting blade includes teeth extending along a second blade edge parallel to the first blade edge. The cutting blade is supported relative to the stationary blade such that the cutting teeth are moveable over the stationary blade to cut hair. The cutting blade includes a top surface and a bottom surface. The magnet holder is coupled to the cutting blade. The magnet holder includes an elongate portion extending along the top surface of the cutting blade and a lower portion extending through the cutting blade. The magnet generates a tensioning force between the cutting blade and the stationary blade.

Another embodiment of the invention relates to a hair cutter. The hair cutter includes a housing, a motor positioned within the housing, an electrical storage device and a drive assembly. The electrical storage device is configured to selectively distribute electrical energy to the motor. The drive assembly is coupled to the motor and includes a finger. The hair cutter further includes a magnetic blade assembly. The magnetic blade assembly has a first blade with teeth extending along a first blade edge and a second blade with teeth extending along a second blade edge parallel to the first blade edge and supported relative to the first blade. The second blade includes a recess configured to engage the finger of the drive assembly. The magnetic blade assembly further includes a magnet holder coupled to the second blade. The magnet holder includes an elongate portion extending along a top surface of the second blade. A magnet is supported by the magnet holder and the magnet extends through the second blade. The magnet generates a tensioning force between the second blade and the first blade.

Another embodiment of the invention relates to a magnetic blade assembly for a yokeless hair cutter. The magnetic blade assembly includes a first blade, a second blade, a magnet holder, and a magnet. The first blade includes teeth extending along a first blade edge. The second blade includes teeth extending along a second blade edge parallel to the first blade edge, the second blade supported relative to the first blade. The magnet holder is engaged with the second blade. The magnet is supported by the magnet holder. At least a portion of the magnet extends through a bore defined within the second blade. The magnet generates a tensioning force between the second blade and the first blade that maintains a cutting force across the second blade edge.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a hair cutting device with a detachable blade assembly according to an exemplary embodiment.

FIG. 2 is a perspective view of the hair cutting device of FIG. 1 with the drive cap removed.

FIG. 3 is a top perspective view of a detachable blade assembly.

FIG. 4 is a rear perspective view of the detachable blade assembly.

FIG. 5 is a side view of the detachable blade assembly.

FIG. 6 is a partially exploded view of the detachable blade assembly of FIG. 3.

FIG. 7 is an exploded view the detachable blade assembly of FIG. 3.

FIG. 8 is a top perspective view of a detachable blade assembly, according to another exemplary embodiment.

FIG. 9 is a rear perspective view of the detachable blade assembly of FIG. 8.

FIG. 10 is a side view of the detachable blade assembly of FIG. 8.

FIG. 11 is an exploded view the detachable blade assembly of FIG. 8.

FIG. 12 is a front perspective view of a cutting blade and magnet of the detachable

blade assembly of FIG. 8.

FIG. 13 is a top perspective view of the cutting blade of FIG. 12.

FIG. 14 is a bottom perspective view of the magnet holder of FIG. 12.

FIG. 15 is top perspective view of a detachable blade assembly according to another exemplary embodiment.

FIG. 16 is a side view of the detachable blade assembly of FIG. 15.

FIG. 17 is a cross-sectional view of the detachable blade assembly taken along line 17-17 of FIG. 16.

FIG. 18 is an exploded view of the detachable blade assembly of FIG. 15.

FIG. 19 is a top perspective view of the cutting blade and a frame with the magnet holder removed.

FIG. 20 is a top perspective view of the frame of the detachable blade assembly of FIG. 15.

FIG. 21 is top perspective view of the magnet holder and magnets of the detachable blade assembly of FIG. 15.

FIG. 22 is a top perspective view of a detachable blade assembly, according to another exemplary embodiment.

FIG. 23 is a side view of the detachable blade assembly of FIG. 22.

FIG. 24 is a cross-sectional view of the detachable blade assembly taken along line 24-24 of FIG. 23.

FIG. 25 is an exploded view of the detachable blade assembly of FIG. 22.

FIG. 26 is a perspective view of a lower blade of the detachable blade assembly of FIG. 22.

FIG. 27 is a top perspective view of a bearing card of the detachable blade assembly of FIG. 22.

FIG. 28 is a perspective view of a bearing holder of the detachable blade assembly of FIG. 22.

FIG. 29 is a top perspective view of the cutting blade and magnet holder of the detachable blade assembly of FIG. 22.

FIG. 30 is a top perspective view of the magnet holder and magnets of the detachable blade assembly of FIG. 22.

### DETAILED DESCRIPTION

Referring generally to the figures, various embodiments of a hair cutting device are shown. The hair cutting device includes a blade assembly with an upper or cutting blade supported relative to a lower or stationary blade such that the cutting blade is moveable (i.e., oscillates) relative to the stationary blade. Proper tensioning between the cutting blade and the stationary blade reduces friction on the system, and therefore wear and tear on the blades, and enhances the operational life of the motor. The cutting and stationary blades should be tensioned/pulled together so that the oscillation of the cutting blade does not interfere with the other components of the blade assembly and hair cutting device.

Applicant has found that using a magnetic blade assembly and/or a magnetic force to generate a tensioning force between the cutting and stationary blades allows the tensioning force to be tailored to create the proper tension between the blades to effectively cut hair while also providing a tensioning force which reduces friction between the blades. The reduction of friction between the blades which reduces load on the motor and improves overall efficiency of the system. For example, a magnet positioned above the upper or cutting blade and/or between the blades creates an attractive force between the blades and reduces the friction of oscillation of the cutting blade. The tensioning force between the cutting blade and the stationary blade attractive or repulsive.

Applicant has found the magnetic tensioning systems discussed herein are usable for yokeless (i.e., without a yoke) clipper designs and provide a more uniform force than conventional tensioning structures that use springs. The spring tolerances are difficult to control and therefore provide uneven tension across the blade. Similarly, Applicant believes the magnetic tension system provides more consistent tension across the entire length of blade teeth. Further mechanical springs tend to impart a force trying to center the cutting blade. In the designs discussed herein, the attractions and tension is in an up and/or down direction rather than horizontal like the spring force. As previously noted, the magnetic tensioning system or blade assembly reduces friction specifically by reducing fiction by eliminating the spring leg interaction with the yoke body. Applicant has found this reduction in friction can be seen be improved run-time in hair cutters with battery-operated units. Additionally, Applicant believes the magnetic tensioning system provides consistent cut quality throughout the lifetime of the hair cutter blade, unlike spring tensioning systems which are set to a predetermined position, and therefore, provide less tension over time as the blades wear. Finally, the lack of a large spring component that is required for conventional spring tensioning systems frees or opens space around the blade assembly, allowing for a narrower hair cutting device design. This narrower design allows for an improved line of sight for barber's using the hair cutting device.

Applicant believes the magnetic tensioning assemblies described herein provide improved tensioning performance compared to magnetic tensioning assemblies where the magnets or magnetized components are only positioned between the cutting blade and stationary blade. Specifically, when the magnet is only positioned between the blades, Applicant has found the magnets selects or chooses one of the cutting blade and stationary blade over the other blade meaning a constant tensioning force is not applied through the blade assembly.

Further, Applicant believes the magnetic tensioning assembly discussed herein creates a magnetic system with an improved tensioning performance (i.e., increased magnetic force) compared to conventional magnetic tensioning assemblies that only use magnets and/or a magnetic component. In a specific embodiment, a magnet is mounted through the cutting blade. In a specific embodiment, the cutting blade is ceramic. Applicant has found the positioning and shape/dimensions of the magnets discussed herein provide sufficient tensioning force for consistent operation of the hair cutting device.

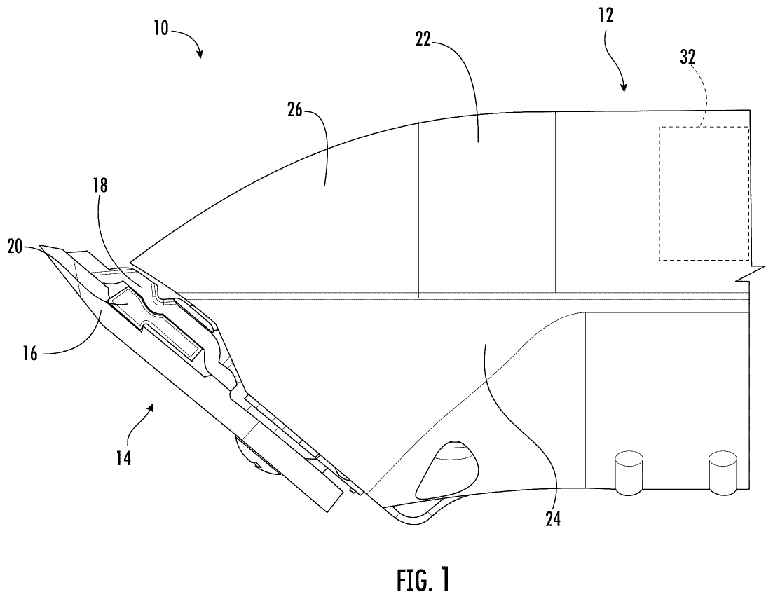

Referring to FIG. 1, a perspective view of a hair cutting device, shown as a hair clipper 10, is shown according to an exemplary embodiment. Hair clipper 10 includes a body or handle 12 and a blade assembly, shown as magnetic blade assembly 14. Magnetic blade assembly 14 includes a lower or stationary blade 16, an upper or cutting blade 18 and a magnet 20. The cutting blade 18 moves or oscillates to cut hair as cutting teeth 17 of cutting blade 18 move or oscillate over stationary blade 16. Cutting blade 18 has teeth 17 extending from a cutter blade edge. In other words, as cutting blade 18 oscillates over stationary blade 16 in the first direction, the teeth 17 on cutting blade 18 and teeth 15 of stationary blade 16 capture hair follicles and cooperate to cut hair.

A distance between the blade edge of stationary blade 16 and the blade edge of cutting blade 18 defines a blade gap. Translation of cutting blade 18 in a transverse direction to the direction of oscillation changes the cut-length during operation of hair clipper 10.

Handle 12 includes an upper housing 22, a lower housing 24 and a drive cap 26. In various embodiments, handle 12 is a single, continuous, and/or integral part, such that upper housing 22, lower housing 24 and drive cap 26 are permanently joined and/or fabricated as an integral continuous component or unitary part. In other embodiments, upper housing 22 is fabricated separately from lower housing 24 and joined or coupled to form handle 12 (e.g., using fasteners).

In various embodiments, cutting blade 18 is formed from a ceramic material. In a specific embodiment, cutting blade 18 is formed from Zirconium Dioxide (ZrO2). In various embodiments, the cutting blade 18 is formed from one of a ceramic material, carbon steel, or stainless steel. In various embodiments, stationary blade is formed from one of carbon steel and stainless steel. In various embodiments, the magnet 20 is a permanent magnet. In specific embodiments, magnet 20 is formed from a rare earth magnet. In a specific embodiment, magnet 20 is formed from Neodymium.

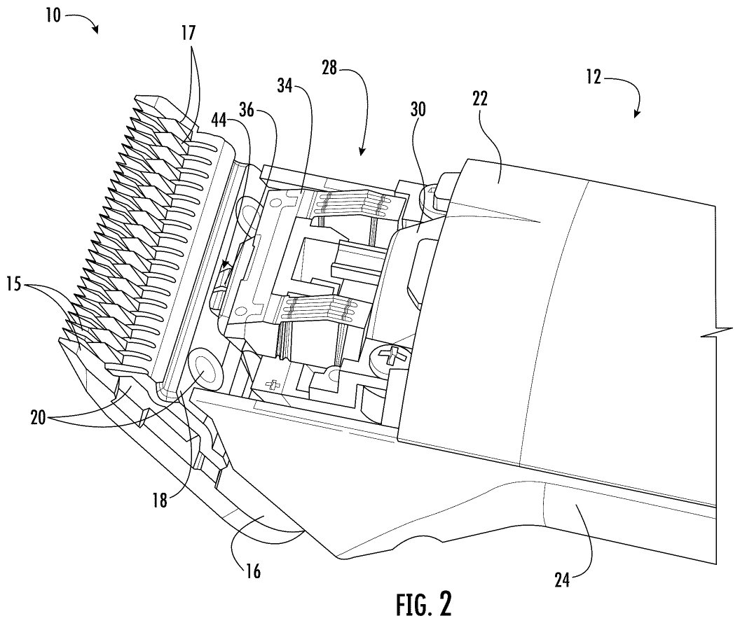

Referring to FIGS. 1-2, details of hair clipper 10 are shown according to an exemplary embodiment. A motor 30 is positioned near the magnetic blade assembly 14 and is offset by a counterweight provided by an internally housed energy storage device shown schematically as battery 32 at end of handle 12 that opposes the end coupled to magnetic blade assembly 14. Motor 30 and battery 32 are housed within an internal cavity of handle 12.

In a specific embodiment, motor 30 is a rotary DC electric motor 30. In other embodiments, motor 30 is a pivot motor or a magnetic motor that generates oscillating or reciprocating movement for blade assembly 14. In other embodiments, motor 30 is an AC electric motor or any other suitable motor for generating oscillating or reciprocating movement for magnetic blade assembly 14. As illustrated, motor 30 is configured to operate on battery power (e.g., cordless), but may be configured to operate with electricity from any suitable electric source, e.g., a hair clipper plugged into an outlet.

A drive assembly 28 is positioned within handle 12 and couples magnetic blade assembly 14 to motor 30. Drive assembly 28 includes a drive component 34 with an engagement end or finger 36 configured to engage cutting blade 18. In a specific embodiment, drive assembly 28 includes an eccentric drive to convert rotational motion from the motor 30 such that the drive assembly 28 creates translational or linear driving motion for cutting blade 18. In other words, cutting blade 18 moves linearly along the blade edge of stationary blade 16 when motion is imparted from motor 30.

In various embodiments, magnetic blade assembly 14 is a yokeless blade assembly such that there is no yoke coupled to the cutting blade 18. In such embodiments, cutting blade 18 includes a recessed section or portion 44. In specific embodiments, recessed portion 44 is positioned in a rear, middle portion of cutting blade 18. Recessed section 44 includes an engagement surface 46. During operation of hair clipper 10, finger 36 of the drive assembly 34 is positioned within recessed portion 44. Finger 36 engages with recessed portion 44 and/or engagement surface 46 to move cutting blade 18.

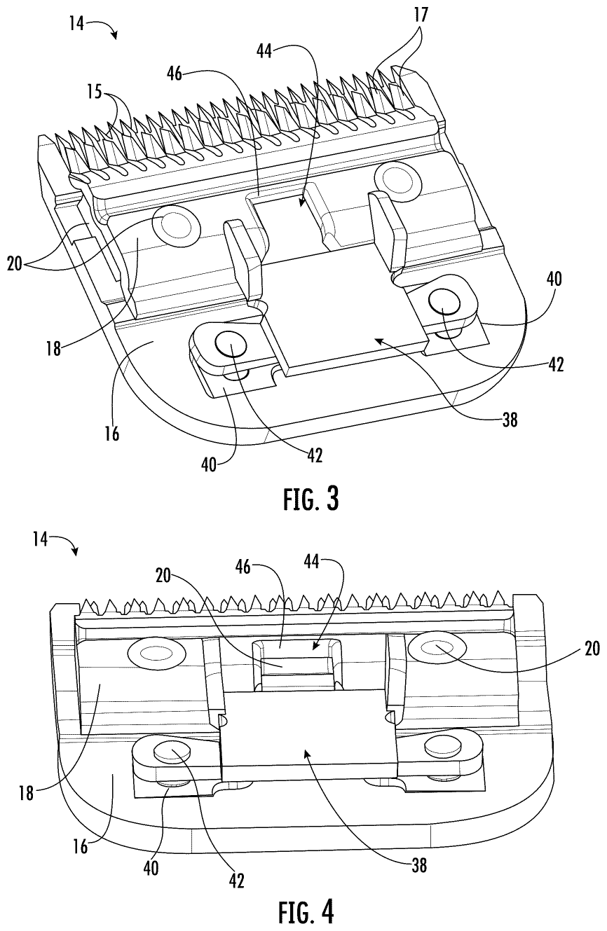

Referring to FIGS. 3-5, details of magnetic blade assembly 14 are shown, according to an exemplary embodiment. As noted above, Applicant believes the magnet designs discussed herein provide or generate a tensioning force between the cutting blade and the stationary blade that maintains a continuous cutting force across the blade edge of the cutting blade to provide a more consistent force.

In a specific embodiment, magnet 20 includes an elongate portion extending along a bottom surface 51 of cutting blade 18 and an upper portion 58 extending through cutting blade 18. In a specific embodiment, the magnet 20 is at least partially overmolded in plastic. In such an embodiment, a cylindrical feature is permanently coupled or fixed to the cutting blade 18. In a specific embodiment, thermoplastic or heat staking is used to join the cylinder feature to the cutting blade 18. Bottom surface 51 is a downward surface that faces stationary blade 16 when magnetic blade assembly 14 is fully assembled. The magnet 20 generates a tensioning force between cutting blade 18 and stationary blade 16. The upper portion 58 of magnet 20 extends through one or more bores 60 defined in cutting blade 18. Upper portion 58 of the magnet 20 extends past or beyond a top surface 48 of the cutting blade 18.

In various embodiments, upper portion 58 extends a distance past or above top surface 48 of cutting blade. A width of cutting blade 18 is defined by the blade edge from which cutting teeth 15 extend. In various embodiments, the elongate portion of magnet 20 extends along a majority of the width of cutting blade 18. In various embodiments, the elongate portion extends along greater than 50% of the width, greater than 75% of the width, and greater than 90% of the width of the cutting blade 18. In a specific embodiment, the elongate portion of magnet 20 extends along the entire width of cutting blade 18. In various embodiments, the elongate portion of magnet 20 extends a minimum width of about 1 inch (e.g., 1 inch plus or minus 0.2 inches).

In various embodiments, the blade assembly further includes a bracket 38. Bracket 38 is coupled to the stationary blade 16 and removably couples the magnetic blade assembly 14 to the housing. Bracket 38 includes projections 64 that are configured to engage handle 12 of hair clipper 10. Bracket 38 further includes bores 66 to allow for coupling to stationary blade 16. Bracket 38 is positioned behind, or to the rear of cutting blade 18 in the orientation shown in FIGS. 3-4.

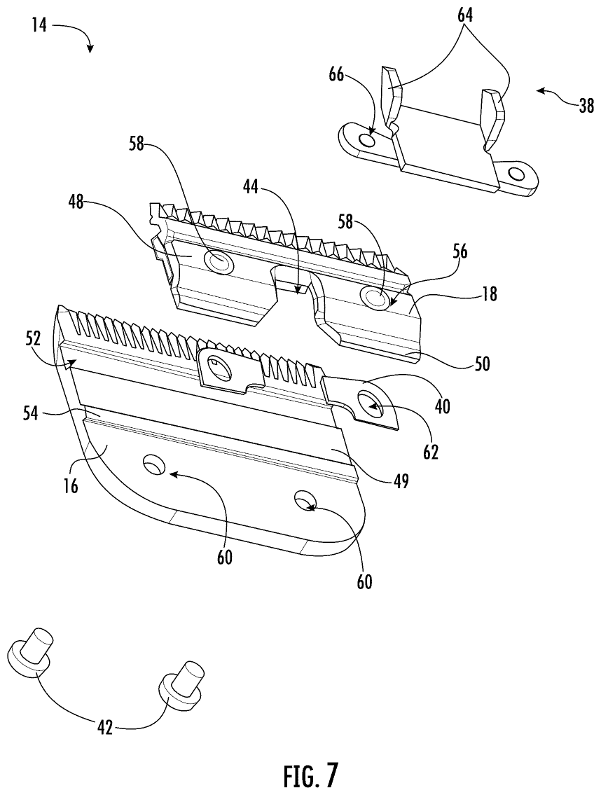

In a specific embodiment, fasteners 42 extend through bores 60 (see e.g., FIG. 7) in stationary blade 16 and bores 66 of bracket 38 to couple bracket 38 to magnetic blade assembly 14. In a specific embodiment, washers 42 which include bores 62 are positioned between bracket 38 and stationary blade 16.

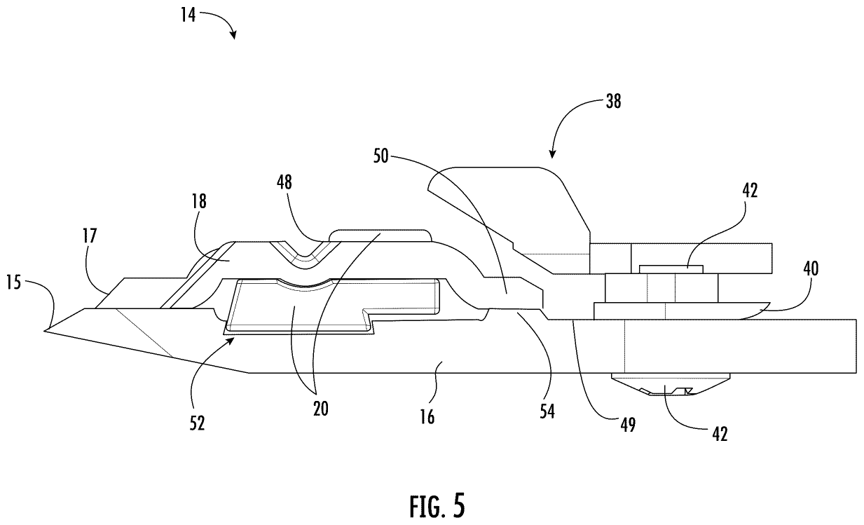

Referring to FIG. 5, a side view of magnetic blade assembly 14 is shown, according to an exemplary embodiment. Magnet 20 includes a lower surface that faces an upper surface of stationary blade 16. In a specific embodiment, a gap or space is defined between the lower surface of magnet 20 and the upper surface of stationary blade 16. Applicant believes the tensioning force produced reduces friction and/or wear when gap has a chosen dimension or length. In various embodiments the distance is less than 0.03 inches and more specifically less than 0.02 inches. In a specific embodiment, the distance is between 0.005 and 0.02 inches and more specifically between 0.01 and 0.015 inches.

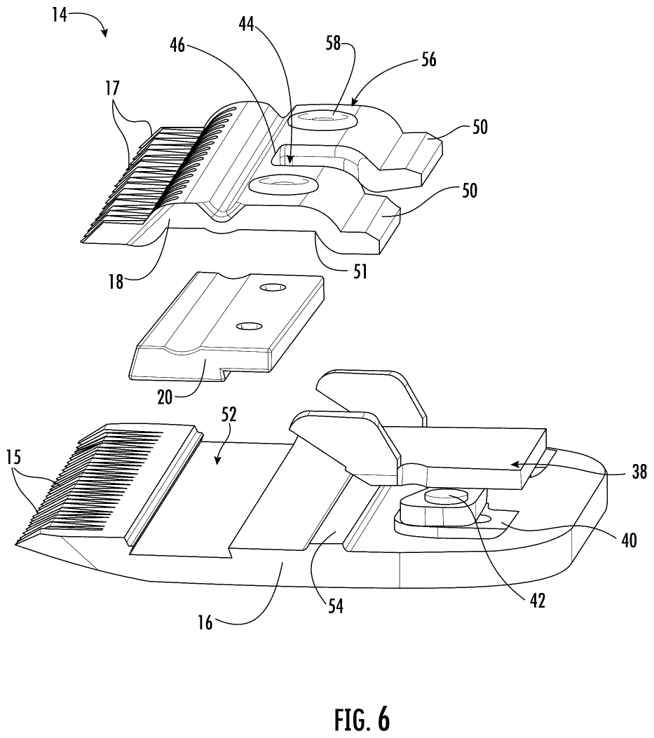

Referring to FIGS. 6-7, exploded views of magnetic blade assembly 14 are shown according to an exemplary embodiment. Cutting blade 18 further includes feet 50 that protrude from cutting blade 18 in a rearward direction. Feet 50 are disposed on cutting blade 18 when magnetic blade assembly 14 is fully assembled creating a vertical gap between upper and lower blades 16, 18. A distance and/or space between feet 50 allows cutting blade 18 to reciprocate with respect to stationary blade 16 without causing feet 50 to hit or interfere with drive assembly 28. When assembled, feet 50 are positioned on an upward projection 54 of stationary blade 16.

Stationary blade 16 further includes a recess 52 extending in a parallel orientation to the blade edge of stationary blade 16. The elongate portion of magnet 20 is positioned within the recess of the stationary blade 16 when the magnetic blade assembly 14 is fully assembled. Recess 52 is positioned between teeth 15 and/or the blade edge and the upward projection 54.

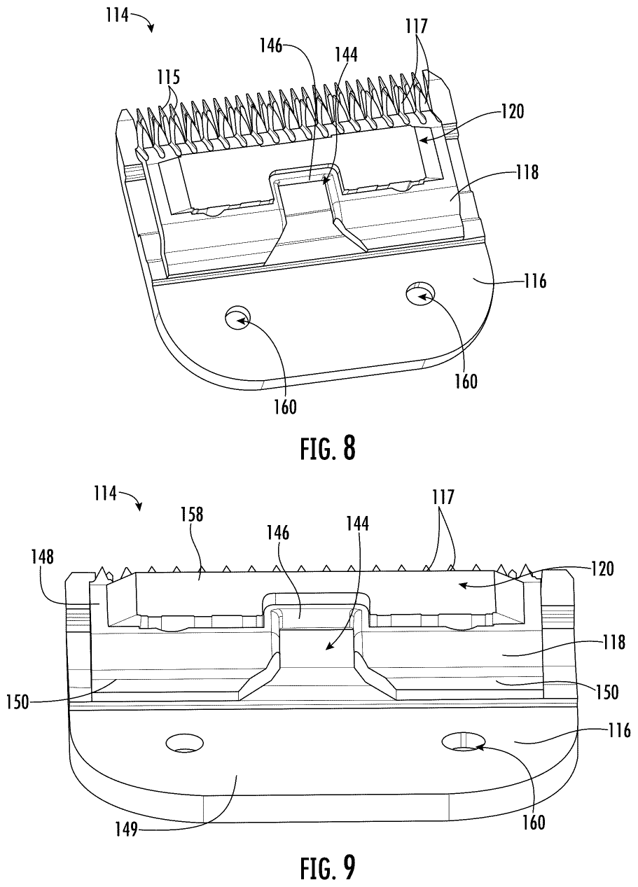

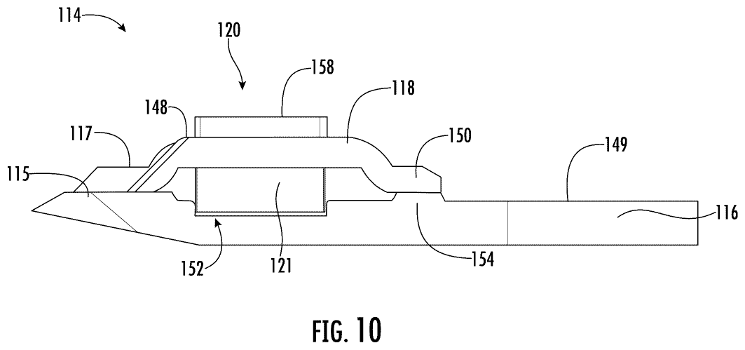

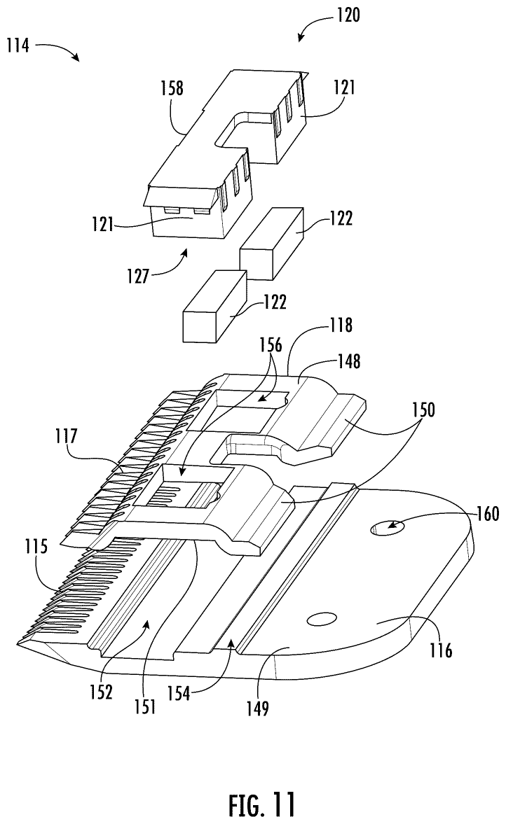

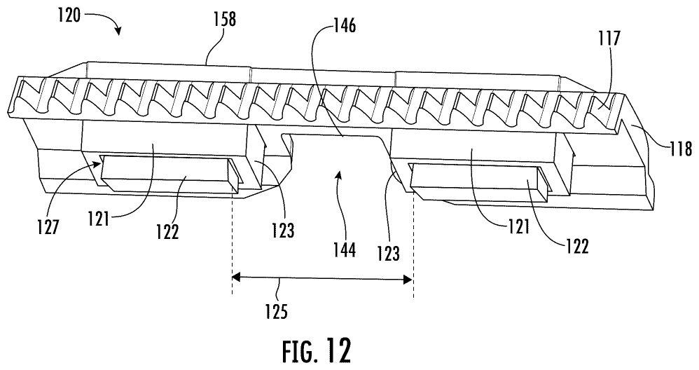

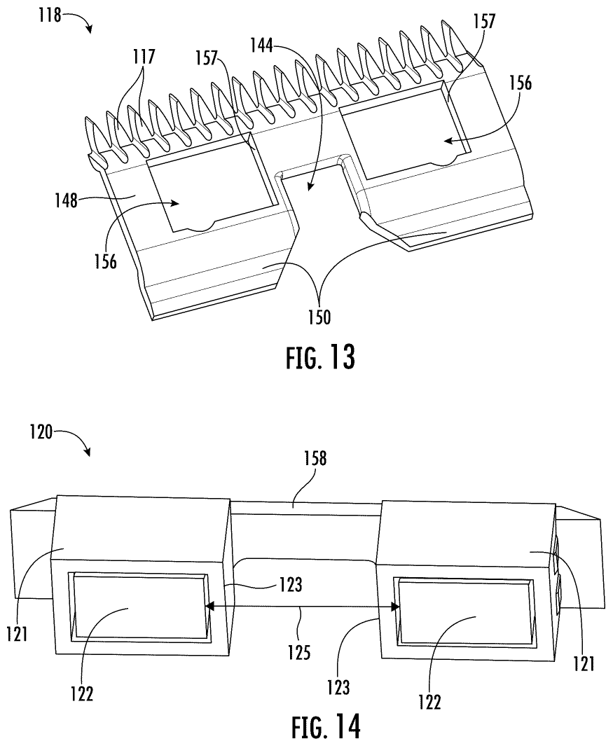

FIGS. 8-14 illustrate another embodiment of a magnetic blade assembly 114 that can be utilized with a hair cutting device such as hair clipper 10 and bracket 38. Magnetic blade assembly 114 includes an upper or cutting blade 118, a lower or stationary blade 116, and a magnet 20. Magnetic blade assembly 114 is substantially the same or similar to the embodiment of blade assembly 14 shown in FIGS. 1-7, except for the differences described herein. Applicant has found such a magnetic assembly provides for a simplified assembly due to the reduced number of components. Additionally, a relatively wider magnet can be used on the opposing sides of the recessed section 144 (i.e., the drive slot).

Referring to FIGS. 8-14, magnet holder 120 includes an elongate or bar portion 158 and one or more lower sections 121. Elongate portion 158 extends along a top surface 148 of cutting blade 118. One or more lower sections 121 extend through bores 156 defined in cutting blade 118 and are positioned between cutting blade 118 and stationary blade 116 when magnetic blade assembly 114 is fully assembled. In various embodiments, the magnet holder 120 is configured to hold one or more permanent magnets. In specific embodiments, magnet holder 120 holds two permanent magnets 122. In other words, each lower section 121 includes a cavity configured to receive and secure a magnet 122 within the holder 120. In a specific embodiment, magnet 122 is inserted and molded into holder 120. In a specific embodiment, magnet holder 120 is formed from plastic. In specific embodiments, permanent magnet 122 is formed from a rare earth magnet. In a specific embodiment, magnet 122 is formed from Neodymium.

A width of cutting blade 118 is defined by the blade edge from which cutting teeth 115 extend. In various embodiments, the elongate portion 158 of magnet 120 extends along a majority of the width of cutting blade 118. In various embodiments, the elongate portion extends along greater than 50% of the width, greater than 75% of the width, and greater than 90% of the width of the cutting blade 18. In a specific embodiment, the elongate portion 158 of magnet 120 extends along the entire width of cutting blade 118. In various embodiments, elongate portion 158 extends a maximum width equal to the width of blade 118.

In various embodiments, elongate portion 158 extends a distance past or above top surface 148 of cutting blade 118. In a specific embodiment, magnet holder 120 includes a pair of lower sections 121 extending through bores 156 in cutting blade 118. Each lower section 121 includes an inward facing surface 123.

In a specific embodiment, magnet holder 120 holds and/or secures two magnets 122 to the magnetic blade assembly 124. A distance 125 between the two magnets 122 is defined by the distance between inward facing surfaces 123 of each magnet 122. In a specific embodiment, a minimum distance between magnets 122 is a about 0.284 inches (e.g., 0.284 inches plus or minus. 0.05 inches).

In a specific embodiment, a gap or space is defined between the lower surface of magnet 122 and the upper surface of stationary blade 116. Applicant believes the tensioning force produced reduces friction and/or wear when gap has a chosen dimension or length. In various embodiments the distance is less than 0.03 inches and more specifically less than 0.02 inches. In a specific embodiment, the distance is between 0.005 and 0.02 inches and more specifically between 0.01 and 0.015 inches.

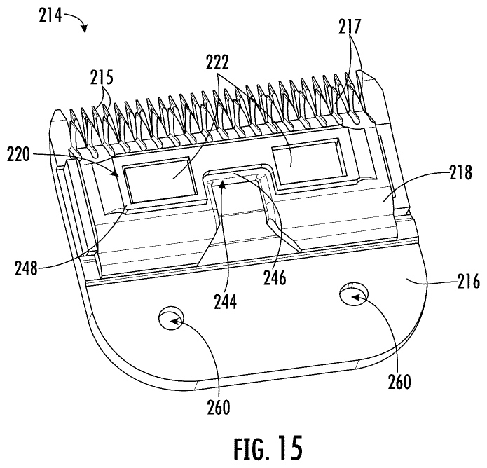

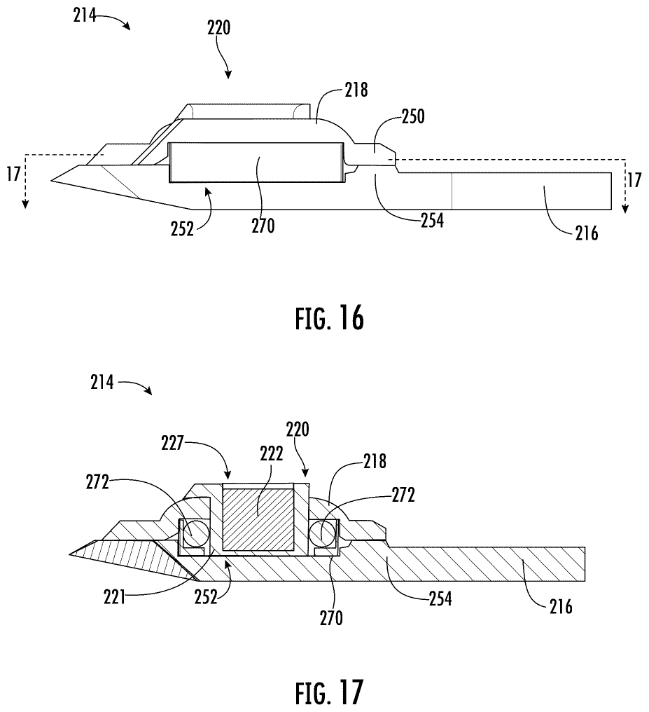

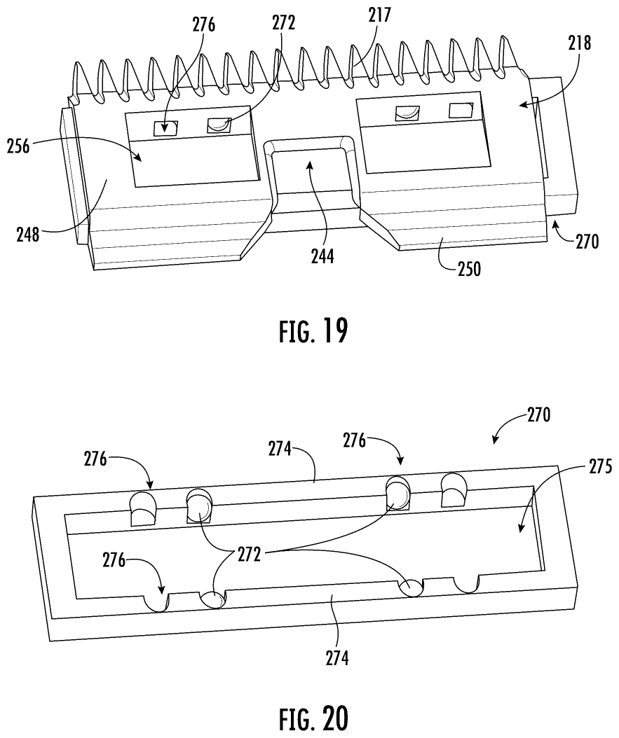

FIGS. 15-21 illustrate another embodiment of a magnetic blade assembly 214 that can be utilized with a hair cutting device such as hair clipper 10 and bracket 38. Magnetic blade assembly 214 includes an upper or cutting blade 218, a lower or stationary blade 216, and one or magnets 222. Magnetic blade assembly 214 is substantially the same or similar to the embodiment of blade assembly 14 and blade assembly 114 except for the differences described herein.

As will be discussed in greater detail below, the magnets 222 are positioned in a magnet holder 220 that has a cavity 227 that is upward facing (e.g., facing in a direction toward cutting blade 218). In other words, the magnetic blade assembly 214 has the magnets arranged in a position such that they come from the top of the blade assembly down (e.g., down relative to cutting blade). Applicant believes this design allows for tensioning or pulling of the entire blade assembly system down compared to other designs where the magnets are positioned below the cutting blade and extend upward (e.g., bottom-up assemblies). Additionally, Applicant has found such a design allows for more precise control over the distance or gap between the magnets 222 and the stationary blade 216 and therefore provides a more constant tension. Furthermore, the upward facing cavities 227 allow for easy modification of the magnets 222 (e.g., grade of magnets can be changed). Finally, Applicant has found improved case of assembly because the magnets 222 do not come into direct contact with a metal cutting blade as they would in a bottom-up assembly.

As shown in FIG. 17, magnet holder 220 includes one or more cavities 227 to hold one or more magnets 222 to provide tensioning. A gap or space is defined between the lower surface of magnet 222 and the upper surface of stationary blade 216. In various embodiments, a lower portion of magnet holder 220 is positioned between magnet 222 and stationary blade 216. In a specific embodiment, magnet holder 220 is formed from plastic.

Applicant believes the tensioning force produced reduces friction and/or wear when gap has a chosen dimension or length. In various embodiments the distance is less than 0.03 inches and more specifically less than 0.02 inches. In a specific embodiment, the distance is between 0.005 and 0.02 inches and more specifically between 0.01 and 0.015 inches.

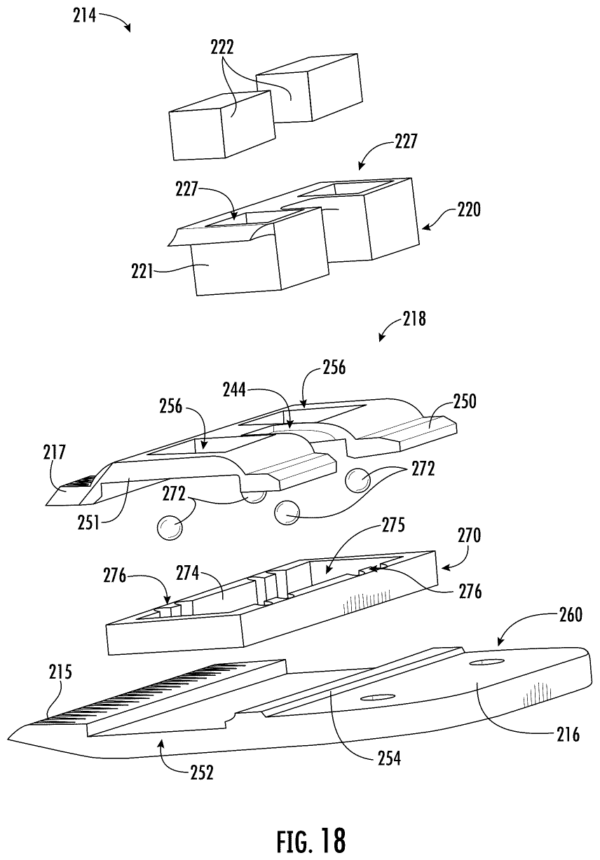

As shown in FIG. 18, magnetic blade assembly 214 includes a bearing system. Applicant has found the addition of a bearing system allows further reduces friction in the system as the cutting blade 218 moves reducing the temperature of temperature of the hair clipper. In various embodiments, the bearing system includes a frame 270. Frame 270 is positioned between stationary blade 216 and cutting blade 218 when the magnetic blade assembly 214 is assembled. Frame 270 includes an opening 275 extending through the center or middle of the frame 270. When assembled, magnet holder 220 is received within opening 275 and at least partially surrounded by the frame 270.

Frame 270 includes longitudinally extending walls 274 (i.e., along the width of the blades) with bearing recesses 276 defined in the longitudinally extending walls. Magnetic assembly 214 further includes a plurality of bearings 272 (e.g. bearing roller balls). In a specific embodiment, the blade assembly 214 includes four bearings 272. In other embodiments, the blade assembly 215 may include a different number of bearings 6, 8, 10, etc. In various embodiments, bearings 272 are formed from a metal material such as stainless steel. In such embodiments, the magnets 222 secure the bearings 272 in a position contacting the magnet holder 220. In various other embodiments, the bearings are formed from non-magnetic materials, such as high temperature plastics.

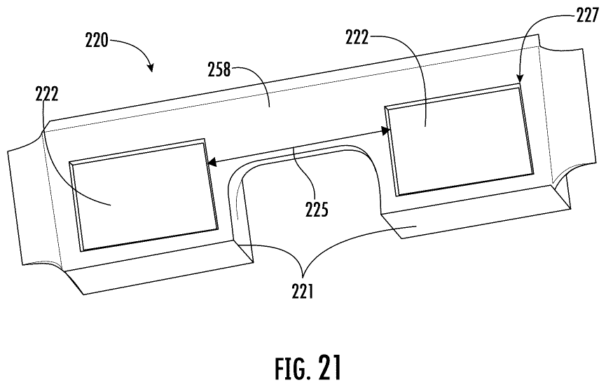

As shown in FIG. 21, in a specific embodiment, magnet holder 220 holds and/or secures two magnets 222 to the magnetic blade assembly 214. A distance 225 between the two magnets 222 is defined by the distance between inward facing surfaces of each magnet 222. In a specific embodiment, a minimum distance between magnets 222 is a about 0.284 inches (e.g., 0.284 inches plus or minus 0.05 inches).

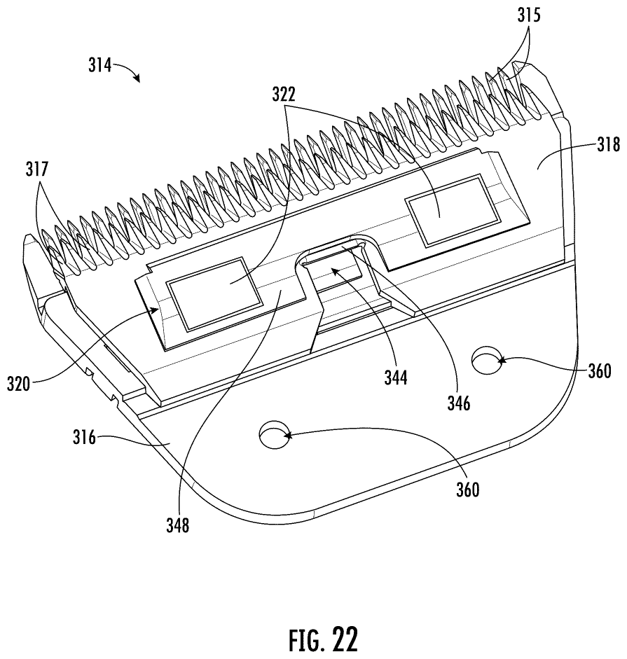

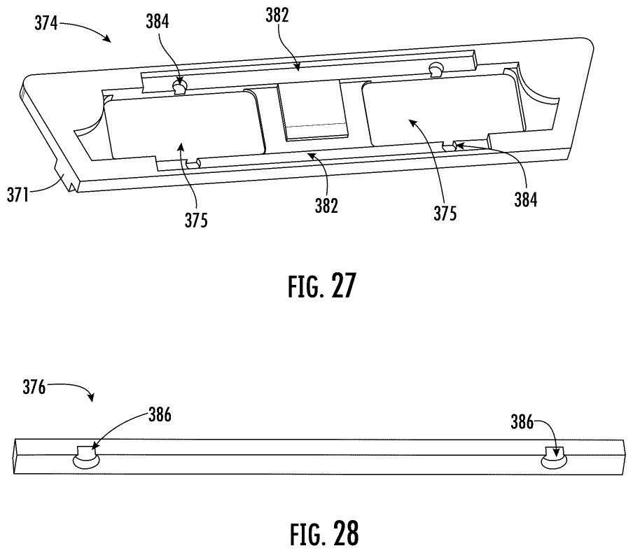

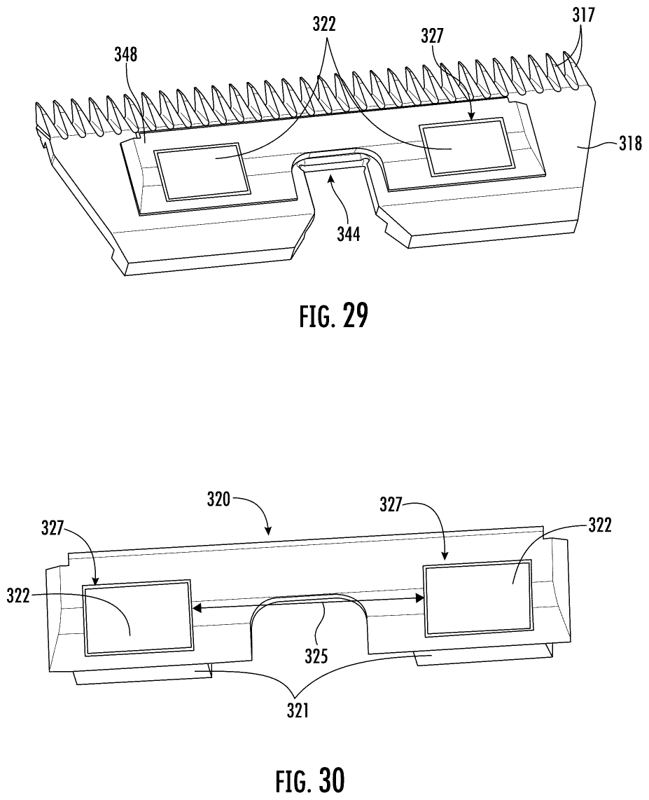

FIGS. 22-30 illustrate another embodiment of a magnetic blade assembly 314 that can be utilized with a hair cutting device such as hair clipper 10 and bracket 38. Using a relatively wider blade for a hair cutting device allows for more hair to be cut at once (i.e., during a pass with the hair cutting device) which improves the speed of the hair cut and reduces wear on the user. As will be generally understood, a wider blade requires a different magnetic blade assembly to achieve the advantages previously discussed (e.g., magnet size, attachment structures, distance between magnets, etc.). Magnetic blade assembly 314 includes an upper or cutting blade 318, a lower or stationary blade 316, and one or magnets 322. Magnetic blade assembly 314 is substantially the same or similar to the embodiment of blade assembly 14, blade assembly 114 and blade assembly 214 except for the differences described herein.

As shown in FIG. 24, magnet holder 320 includes one or more cavities 327 to hold one or more magnets 322 to provide tensioning. In other words, magnet 322 is supported by the magnet holder 320 with the magnet 322 extending through cutting blade 318. A gap or space is defined between the lower surface of magnet 322 and the upper surface of stationary blade 316. In various embodiments, a lower portion of magnet holder 320 is positioned between magnet 322 and stationary blade 316. In a specific embodiment, magnet holder 320 is formed from plastic. In a specific embodiment, magnet holder 320 is configured to hold two magnets 322. Applicant believes the tensioning force produced reduces friction and/or wear when gap has a chosen dimension or length. In various embodiments the distance is less than 0.03 inches and more specifically less than 0.02 inches. In a specific embodiment, the distance is between 0.005 and 0.02 inches and more specifically between 0.01 and 0.015 inches.

When blade assembly 314 is assembled, magnet holder 320 is coupled to cutting blade 318. Magnet holder 320 includes an elongate portion 348 extending along a top surface of cutting blade 318. The top surface of cutting blade 318 faces away from lower blade 316 (e.g., upward, toward hair clipper housing). The magnet holder 320 further includes a lower portion 321 extending away from the elongate portion 348 in a downward direction (e.g., toward lower blade 316). Lower portion 321 extends through the cutting blade 318. In various embodiments, an upper portion of magnet 322 extends past or beyond the top surface of cutting blade 318. In various embodiments, the lower portion 321 defines the cavity 327 which is sized to receive magnet 322. In such an embodiment, the opening of cavity 327 faces upward, in a direction away from lower blade 316.

In various specific embodiments, magnet holder 320 has a width of about 1.816 inches (e.g., 1.816 inches plus or minus 0.2 inches). Applicant has found the position of magnet holder 320 allows for a more even distribution of the magnetic force across a width of cutting blade 318. In various embodiments, the magnet holder 320 is centered relative to cutting blade 318 to allow for even distribution of the magnetic force.

In various embodiments, cutting blade 318 has a width of about 2.425 inches (e.g., 2.425 inches plus or minus 2 inches. In such an embodiment, the width of cutting blade 318 is measure along the blade edge from which teeth 317 extend. In various embodiments, the magnet holder 320 and specifically, elongate portion 348 extends along greater than 50% of the width, greater than 60% of the width, and greater than 70% of the width of the cutting blade 318. In specific embodiments, magnet holder 320 and specifically, elongate portion 348 extends along between 70% and 80% of the width of cutting blade 318. In a specific embodiment, magnet holder 320 extends along about 75% of the width of cutting blade 318 (e.g., 75% plus or minus. 5%).

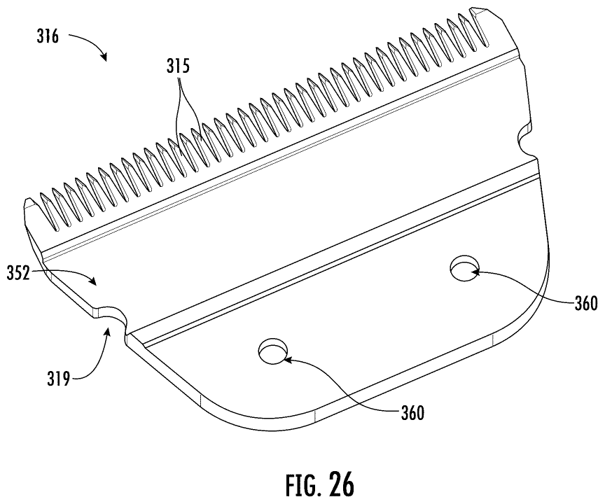

A width of lower blade 316 at the widest point is greater than the width of lower blades 216, 116 and 16. In various embodiments, lower blade 316 has a width that is about 0.700 inches wider than a standard #10 blade. As will be generally understood, a standard #10 blade has a width of approximately 1.936 inches. As can be seen in FIG. 26 the width of lower blade 316 increases as sides of lower blade 316 approach a blade edge from which teeth 315 extend.

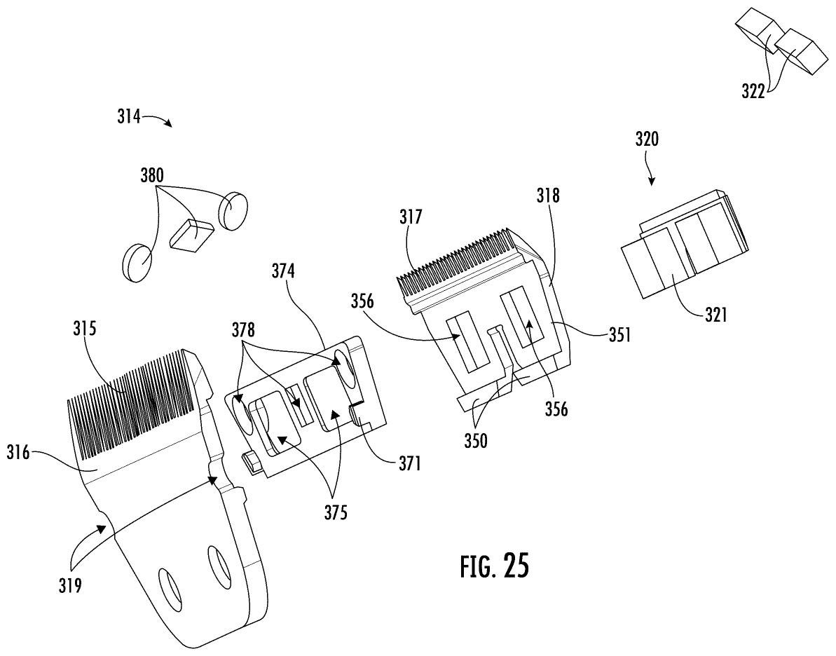

As shown in FIGS. 25-28, magnetic blade assembly 314 includes a bearing system 370. Applicant has found the addition of a bearing system allows further reduces friction in the system as the cutting blade 318 moves reducing the temperature of temperature of the hair clipper. Furthermore, the position of the bearing system (i.e., mounted in the lower blade 316) acts as a guide such that cutting blade 318 travels straight and maintains a consistent blade gap between the first blade edge and the second blade edge defines the blade gap.

In various embodiments, the bearing system includes a bearing cart or frame 374. Frame 374 is positioned between stationary blade 316 and cutting blade 318 and bearing 372 is positioned between frame 374 and cutting blade 318 when the magnetic blade assembly 314 is assembled. Frame 374 includes an opening 375 extending through the center or middle of the frame 374. When assembled, magnet holder 320 is received within opening 375 and at least partially surrounded by the frame 374.

As shown in FIG. 25, frame 374 includes one or more magnet recesses 378 in the surface that faces lower blade 316. One or more mounting magnets 380 are used to mount frame 374 to blade assembly 314. In a specific embodiment, the magnets 380 are molded to frame 374 for case of assembly. In various specific embodiments, frame 374 is mounted to blade assembly 314 using magnets 380. As previously discussed, the bearing system and frame 374 act as a guide for movement of cutting blade 318 relative to stationary blade 316 (e.g., in a straight direction). In this manner, the blade gap or distance between the cutting edge of cutting blade 318 and the cutting edge of stationary blade 316 can be kept consistent.

In various specific embodiments, frame 374 includes two openings 375. In a specific embodiment, opening 375 has a width of about 0.711 inches (e.g., 0.711 inches plus or minus 0.05 inches). In various embodiments, a height of opening 375 is about 0.358 inches (e.g., 0.358 inches plus or minus 0.05 inches). Applicant has found the size of openings 375 allows for a more even distribution of the magnetic force across a width of cutting blade 318.

The bearing system 370 further includes a bearing holder 376. Bearing holder 376 is configured to be positioned within a recessed section 382 on frame 374 when the bearing system is assembled. Bearing holder 376 includes a bearing recess 386 that corresponds to a bearing recess 384 formed within recessed section 382 of frame 374. When assembled, the bearings 372 are secured between the bearing holder 376 and frame 374 (see e.g., FIG. 24). In a specific embodiment, bearing system 370 includes two bearing holders 376 positioned within each recessed section 382 of frame 374. When blade assembly 314 is assembled, frame 374 is positioned between lower blade 316 and cutting blade 318, the bearing holder 376 is engaged with the frame 374 and at least one bearing 372 is positioned between the frame 374 and bearing holder 376.

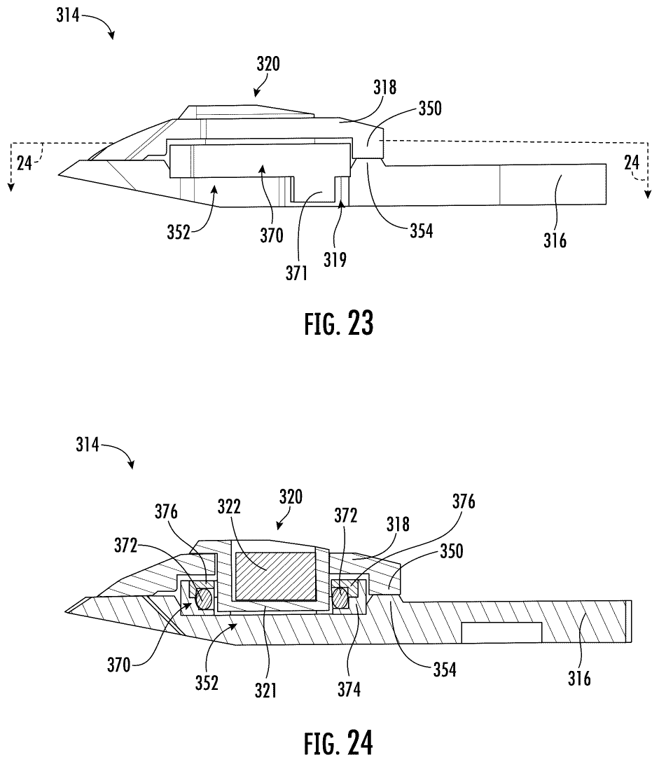

As shown in FIG. 26, lower blade 316 includes a side recess 319 in a side of lower blade 316. In a specific embodiment, lower blade 316 includes a pair of side recesses 319 positioned on opposing sides of lower blade 316 along recess 352. Recess 352 extends in a parallel orientation to the blade edge of lower blade 316. When blade assembly 314 is assembled, projections 371 of frame 374 extend toward lower blade 316 and are positioned within side recesses 319 (see e.g., FIG. 23). When blade assembly 314 is assembled, magnet 322 is positioned within lower portion 321 of magnet holder 320. Magnet holder 320 is positioned within the recess 352 of lower blade 316.

As shown in FIG. 30, in a specific embodiment, magnet holder 320 holds and/or secures two magnets 322 to the magnetic blade assembly 314. A distance 325 between the two magnets 322 is defined by the distance between inward facing surfaces of each magnet 322. In a specific embodiment, a minimum distance between magnets 322 is a about 0.811 inches (e.g., 0.811 inches plus or minus 0.05 inches).

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A magnetic blade assembly, comprising:
a stationary blade having teeth extending along a first blade edge;
a cutting blade having cutting teeth extending along a second blade edge parallel to the first blade edge, and supported relative to the stationary blade such that the cutting teeth are moveable over the stationary blade to cut hair, the cutting blade comprising a top surface and a bottom surface;
a magnet holder coupled to the cutting blade, the magnet holder comprising:
an elongate portion extending along the top surface of the cutting blade; and
a lower portion extending through the cutting blade; and
a magnet positioned within the magnet holder;
wherein the magnet generates a tensioning force between the cutting blade and the stationary blade.

2. The magnetic blade assembly of claim 1, wherein an upper portion of the magnet extends past the top surface of the cutting blade.

3. The magnetic blade assembly of claim 1, wherein the elongate portion of the magnet holder extends along greater than 70% of a width of the cutting blade.

4. The magnetic blade assembly of claim 1, wherein the cutting blade is formed from a ceramic material.

5. The magnetic blade assembly of claim 1, wherein the magnet is a permanent formed from a rare earth magnet.

6. The magnetic blade assembly of claim 1, wherein the stationary blade further comprises a recess extending in a parallel orientation to the first blade edge.

7. The magnetic blade assembly of claim 6, wherein the magnet is positioned within the lower portion of the magnet holder, and wherein the magnet holder is positioned within the recess of the stationary blade when the magnetic blade assembly is assembled.

8. The magnetic blade assembly of claim 1, wherein a distance between the first blade edge and the second blade edge defines a blade gap.

9. A hair cutter comprising:
a housing;
a motor positioned within the housing;
an electrical storage device to store electric energy, the electrical storage device configured to selectively distribute electrical energy to the motor;
a drive assembly coupled to the motor, the drive assembly comprising a finger;
a magnetic blade assembly, comprising:
a first blade having teeth extending along a first blade edge;
a second blade having teeth extending along a second blade edge parallel to the first blade edge and supported relative to the first blade, the second blade comprising a recess configured to engage the finger of the drive assembly;
a magnet holder coupled to the second blade, the magnet holder comprising an elongate portion extending along a top surface of the second blade;
a magnet supported by the magnet holder, the magnet extending through the second blade;
wherein the magnet generates a tensioning force between the second blade and the first blade.

10. The hair cutter of claim 9, further comprising a bearing system, the bearing system comprising:
a frame positioned between the first blade and the second blade; and
a bearing positioned between the frame and the second blade.

11. The hair cutter of claim 10, wherein the first blade further comprises a recess extending in a parallel orientation to the first blade edge, and wherein the frame is positioned within the recess of the first blade.

12. The hair cutter of claim 9, the magnet holder further comprising:
an elongate portion extending along a first surface of the second blade, the first surface facing away from the second blade; and
a lower portion extending away from the elongate portion and through the second blade.

13. The hair cutter of claim 12, wherein the lower portion of the magnet holder defines a cavity, the cavity sized to receive the magnet.

14. The hair cutter of claim 9, further comprising a bracket coupled to the first blade, wherein the bracket removably couples the magnetic blade assembly to the housing.

15. A magnetic blade assembly for a yokeless hair cutter, comprising:
a first blade having teeth extending along a first blade edge;
a second blade having teeth extending along a second blade edge parallel to the first blade edge, the second blade supported relative to the first blade;
a bearing system mounted in the first blade;
a magnet holder engaged with the second blade;
a magnet supported by the magnet holder, wherein at least a portion of the magnet extends through a bore defined within the second blade and wherein the magnet generates a tensioning force between the second blade and the first blade that maintains a cutting force across the second blade edge.

16. The magnetic blade assembly of claim 15, the magnet further comprising an upper surface extending beyond a top surface of the second blade.

17. The magnetic blade assembly of claim 15, wherein the bearing system comprises:
a frame positioned between the first blade and the second blade;
a bearing holder engaged with the frame; and
a bearing positioned between the frame and the bearing holder, and wherein the bearing system acts as a guide for movement of the second blade.

18. The magnetic blade assembly of claim 15, wherein an elongate portion of the magnet holder extends along between 70% and 80% of a width of the second blade.

19. The magnetic blade assembly of claim 15, wherein the magnet includes a lower surface that faces an upper surface of the first blade and wherein a gap is defined between the lower surface of the magnet and the upper surface of the first blade.

20. The magnetic blade assembly of claim 19, wherein a length of the gap is between. 0.005 and 0.02 inches.
